(19) United States
(12) Patent Application Publication
(10) Pub. No.: US 2008/0025305 A1
(43) Pub. Date: Jan. 31, 2008

(54) MULTICASTING SYSTEM AND NETWORK DEVICE TO TRANSMIT DATA AS AN AGENCY AND A METHOD THEREOF

(76) Inventor: Jun Choi, Suwon-si (KR)

Correspondence Address: STANZIONE & KIM, LLP, 919 18TH STREET, N.W., SUITE 440, WASHINGTON, DC, 20006, US

(21) Appl. No.: 11/684,774

(22) Filed: Mar. 12, 2007

(30) Foreign Application Priority Data
Jul. 25, 2006 (KR) 2006-69579

(51) Int. Cl. H04L 12/56

(52) U.S. Cl. 370/390

(57) ABSTRACT

A multicasting system and a network device to transmit data as an agency, and a method of transmitting data as an agency. The multicasting system to transmit data as an agency according to an embodiment of the present general inventive concept includes a first network device to transmit a power saving mode change signal and to change a current mode to a power saving mode, and a second network device to receive the power saving mode change signal from the first network device, and if an information request signal is received from one of the plurality of network devices, to transmit a response data defined by the first network device to the network device which has transmitted the information request signal. Accordingly, although a network device is in a power saving mode, the network device can normally receive data.

### CROSS-REFERENCE TO RELATED APPLICATIONS

This application claims priority under 35 U.S.C. §119(a) from Korean Patent Application No. 2006-0069579, filed Jul. 25, 2006, in the Korean Intellectual Property Office, the entire contents of which are incorporated herein in its entirety by reference.

### BACKGROUND OF THE INVENTION

1. Field of the Invention

The present general inventive concept relates to a multicasting system and a network device to transmit data as an agency in order for other network device to recognize a network device in a power saving mode as a normal device, and a method thereof.

2. Description of the Related Art

Multicast is a method for transmitting e-mail of the same contents, or image or voice data for a video conference to a plurality of people in the network at the same time. The multicast is distinct from unicast for transmitting data packets to a particular person.

In the unicast, as data packets have to be repeatedly transmitted according to the number of recipients, the efficiency of the communication network is fallen. Accordingly, the multicast technology in which many users can transmit and receive data each other at the same time is essential to conversational Internet functions such as video conference between a plurality of people.

Namely, the multicast prevents a waste of network resources due to redundant data transmission and guarantees efficient group operation in real-time, without burdening a participant that does not currently need data.

FIG. 1 illustrates a conventional multicasting system.

With reference to FIG. 1, the multicasting system includes a plurality of network devices 10, 20, 30, 40, and 50 connected to each other via the network. The plurality of network devices 10-50 may be a user terminal 10, a router 20 and a plurality of network printers 30 through 50.

The user terminal 10, the router 20 and the plurality of network printers 30 through 50 may operate in one or more multicast groups as a member, or disconnect from the multicast groups. Additionally, they can communicate with other devices in their respective multicast groups.

The conventional multicasting system is described with reference to an exemplary embodiment where the user terminal 10, the router 20 and the plurality of network printers 30 through 50, as illustrated in FIG. 1, operate in one multicast group, and the user terminal 10 searches the network printers 30 through 50.

The user terminal 10 requests information using an address of its multicast group. The information request is transmitted to other network devices in the multicast group, that is, the router 20 and the network printers 30 through 50.

At least one of the network printers 30 through 50 which correspond to the condition of the information request of the user terminal 10 transmits response data including information such as printer specification, and the response data is transmitted to the user terminal 10 and the corresponding operation is performed.

The network printers 30 through 50 may be turned on for the use of a plurality of users, resulting in a waste of electric power. The network printers 30 through 50 may operate in a power saving mode when not performing a job.

When in power save mode, only a network interface of the network printers 30 through 50 operates and other hardware does not operate. If printing data are input through the network interface, the hardware operates to print the data.

As described above, when the network printers 30 through 50 operate in a power saving mode, other network devices, that is, the user terminal 10 or the router 20 cannot normally receive a response to determine a state or attribute of the network printers 30 through 50.

Therefore, the user terminal 10 or the router 20, which have tried to communicate with the network printers 30 through 50, do not recognize the non-responsive network printers 30 through 50 as devices in the network.

### SUMMARY OF THE INVENTION

The present general inventive concept provides a multicasting system and a network device which combine to form a network device in a power saving mode to normally receive data by a normally operating network device which performs information requests and response data transmission on behalf of the network device in the power saving mode.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a multicasting system which has a plurality of network devices to transmit data as an agency is provided, including a first network device to transmit a power saving mode change signal and to change a current mode to a power saving mode, and a second network device to receive the power saving mode change signal from the first network device, and if an information request signal is received from one of the plurality of network devices, to transmit a response data defined by the first network device to the network device which has transmitted the information request signal.

The second network device may request the response data to be used as a response to the information request signal to the first network device, if the power saving mode change signal is received.

The first network device may transmit a response data to be used as a response to the information request signal along with the power saving mode change signal.

The first network device may transmit an address of a multicast group including the first network device, along with the power saving mode change signal.

The second network device may participate in the multicast group including the first network device as a member using the address of the multicast group, if the power saving mode change signal is received.

The second network device may be removed from the multicast group, if a general mode change signal is received from the first network device.

The foregoing and/or other aspects and utilities of the present general inventive concept may also be achieved by providing a network device to transmit data as an agency, including a network interface to receive a power saving mode change signal from a network device to perform power saving among a plurality of network devices, and a response data defined by the network device to perform power saving, a storage unit to store the received response data, and a controller to transmit the stored response data to the network device, which has transmitted an information request signal, through the network interface, if the information request signal is received from one of the plurality of network devices.

The controller may request the response data to the network device to perform power saving, if the power saving mode change signal is received through the network interface.

The controller may control the network device to participate in a multicast group including the network device to perform power saving as a member, if the power saving mode change signal is received through the network interface.

The controller may control the network device to remove itself from the multicast group, if a general mode change signal is received from the network device to perform power saving through the network interface.

The foregoing and/or other aspects and utilities of the present general inventive concept may also be achieved by providing a method of transmitting data as an agency, including receiving a power saving mode change signal and a response data from a network device to perform power saving among a plurality of network devices, storing the received response data, and if an information request signal is received from one of the plurality of network devices, transmitting the stored response data to the network device which has transmitted the information request signal.

The receiving of the power saving mode change signal and the response data may include receiving the power saving mode change signal from the network device to perform power saving, requesting the response data to the network device to perform power saving, and receiving the response data from the network device to perform power saving.

The method may further include participating in a multicast group including the network device to perform power saving as a member, if the power saving mode change signal is received.

The method may further include removing a device from the multicast group, if a general mode change signal is received from the network device to perform power saving.

The foregoing and/or other aspects and utilities of the present general inventive concept may also be achieved by providing a multicasting system having a plurality of network devices, including a network device to receive response data from one of network devices, to receive an information request signal from another one of the network devices, and to transmit the received response data from the one of the network devices to the another one of the network devices according to the received information request signal as an agency of the one of the network devices.

The network devices may receive a power saving mode change signal from the one of the network devices and transmit a request signal to the one of the network devices according to the received power saving mode change signal.

The network device may transmit the received response data to the another one of the network devices according to a power saving mode change signal of the one of the network devices.

The network device may not send the received response data to the another one of the network devices according to a mode change signal from the one of the network devices.

The one of the network devices may change a mode to a power saving mode upon transmitting the response data to the network device.

The foregoing and/or other aspects and utilities of the present general inventive concept may also be achieved by providing a method of a multicasting system having a plurality of network devices, the method including receiving response data from one of network devices, receiving an information request signal from another one of the network devices, and transmitting the received response data from the one of the network devices to the another one of the network devices according to the received information request signal as an agency of the one of the network devices.

The foregoing and/or other aspects and utilities of the present general inventive concept may also be achieved by providing a multicasting system having a plurality of network devices, including a network device to transmit a power saving mode change signal according to the power saving mode change signal, and to change a mode to a power saving mode upon transmitting response data to the another network device to another network device.

The foregoing and/or other aspects and utilities of the present general inventive concept may also be achieved by providing a method of a multicasting system having a plurality of network devices, the method including transmitting a power saving mode change signal according to the power saving mode change signal; and changing a mode to a power saving mode upon transmitting response data to the another network device to another network device.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a conventional multicasting system;

FIG. 2 illustrates a multicasting system according to an embodiment of the present general inventive concept;

FIG. 3 is a block diagram illustrating a network device to transmit data as an agency according to an embodiment of the present general inventive concept;

FIG. 4 is a flow chart illustrating a method of the network device in a power saving mode of FIG. 2; and

FIG. 5 is a flow chart illustrating a method of the network device to transmit data as an agency of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 illustrates a multicasting system according to an embodiment of the present general inventive concept.

With reference to FIG. 2, the multicasting system includes a plurality of network devices 100, 200, 300, 400, 500, and 600 which participate in one multicasting group. The multicasting system according to an exemplary embodiment of the present general inventive concept includes a first network device in a power saving mode, and a second network device which transmits response data, defined by the first network device, as an agency.

As illustrated in FIG. 2, the plurality of network devices 100 through 600 may be a user terminal 100, a router 200, a plurality of network printers 300 through 500, and a printer server 600.

If the first network device keeps standing by without a job to perform during a predetermined amount of time, the first network device switching to a power saving mode to save standby power. Before switching to the power saving mode, the first network device transmits a power saving mode change signal to the second network device, and accordingly switches the current mode to the power saving mode. The power saving mode change signal reports that a network device in a general mode has switched to the power saving mode.

The first network device may transmit response data to be used as a response to an information request signal from another network device, along with the power saving mode change signal. The response data is data defined by the first network device to respond to the information request signal from other network devices, and may include printer specifications if the first network device is a printer.

Additionally, after the first network device transmits only the power saving mode change signal to the second network device, the first network device can transmit the response data to the second network device if the second network device requests the response data.

The second network device may receive the power saving mode change signal from the first network device. The response data defined by the first network device may be received along with the power saving mode change signal.

Alternatively, after receiving the power saving mode change signal from the first network device, the second network device may request the response data, to be used as a response to the information request signal from other network devices, to the first network device. The information request signal from other network devices may be a search request signal to search the multicast group for a desired device.

The first network device may be one of all the network devices participating in the multicast group, that is, the user terminal 100, the router 200, the plurality of network printers 300 through 500 and the printer server 600. In this embodiment of the present general inventive concept, however, the network printer 400 operates as the first network device.

The second network device may be one of all the network devices participating in the multicast group, that is, the user terminal 100, the router 200, the plurality of network printers 300 through 500 and the printer server 600, except for the first network device. In this embodiment of the present general inventive concept, however, the user terminal 100 operates as the second network device.

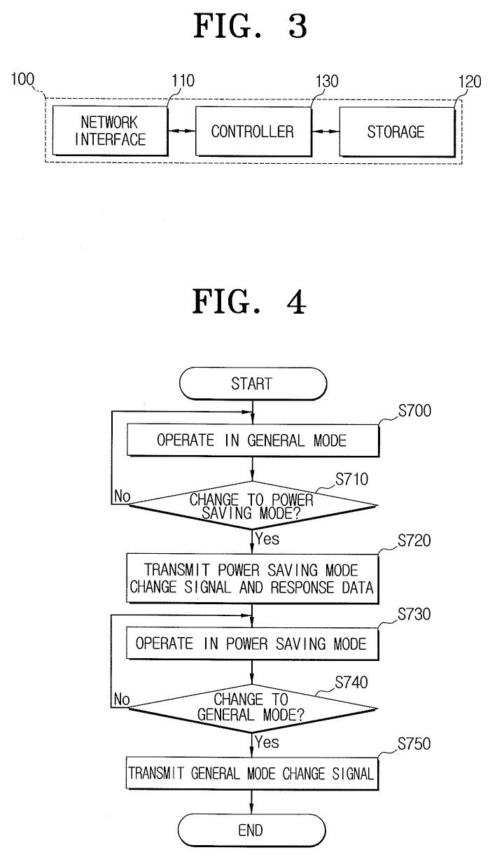

The user terminal 100 receives the power saving mode change signal and the response data from the network printer 400. If the user terminal 100 receives the information request signal from one of other network devices in the multicast group, that is, the router 200, the network printer 300, the network printer 500 and the printer server 600, the user terminal 100 transmits the response data of the network printer 400 to the corresponding network device. The second network device is described in detail with reference to FIG. 3.

FIG. 3 is a block diagram illustrating a network device to transmit data as an agency according to an embodiment of the present general inventive concept.

As described in FIG. 2, the user terminal 100 may operate as the second network device. It is possible that the network printer 400 may operate as the first network device to perform power saving.

With reference to FIG. 3, the user terminal 100 operating as the second network device includes a network interface 110, a storage unit 120 and a controller 130.

The network interface 110 interfaces with other network devices in the multicast group, that is, the router 200, the plurality of network printers 300 through 500, and the printer server 600.

The network interface 110 receives the power saving mode change signal corresponding to a power saving mode and the response data defined by the network printer 400, from the network printer 400.

The network interface 110 receives the information request signal from one of the router 200, the network printer 300, the network printer 500, and the printer server 600.

Moreover, the network interface 110 transmits the response data to the network device which has transmitted the information request signal, among the information request signal from one of the router 200, the network printer 300, the network printer 500, and the printer server 600, by operation of the controller 130.

The storage unit 120 stores the response data received from the network printer 400 by operation of the controller 130. The storage unit 120 may also store response data received from other network devices to perform power saving besides the network printer 400. Accordingly, the response data according to the network devices to perform power saving may be stored in a table format.

The controller 130 controls overall functions of the user terminal 100, that is, controls input and output of signals between the network interface 110 and the storage unit 120.

If the controller 130 receives the power saving mode change signal from the network printer 400 through the network interface 110, the controller 130 may request the response data to the network printer 400. If the response data is received along with the power saving mode change signal, an additional request to obtain the response data is not necessary.

If the controller 130 receives the power saving mode change signal from the network printer 400 through the network interface 110, the user terminal 100 may participate in the multicast group including the network printer 400 as a member. The controller 130 controls the user terminal 100 to participate in the corresponding multicast group using an address of the multicast group received along with the power saving mode change signal.

If the information request signal corresponding to the network printer 400 is received from one of the router 200, the network printer 300, the network printer 500 and the printer server 600 through the network interface 110, the controller 130 transmits the response data stored in the storage unit 120 to the network device which has transmitted the information request signal.

If a general mode change signal is received from the network printer 400 through the network interface 110, the controller 130 controls the user terminal 100 to remove itself from the multicast group. The general mode change signal reports that the network device in the power saving mode has changed to a general mode.

FIG. 4 is a flow chart illustrating a method of the network device in a power saving mode of FIG. 2.

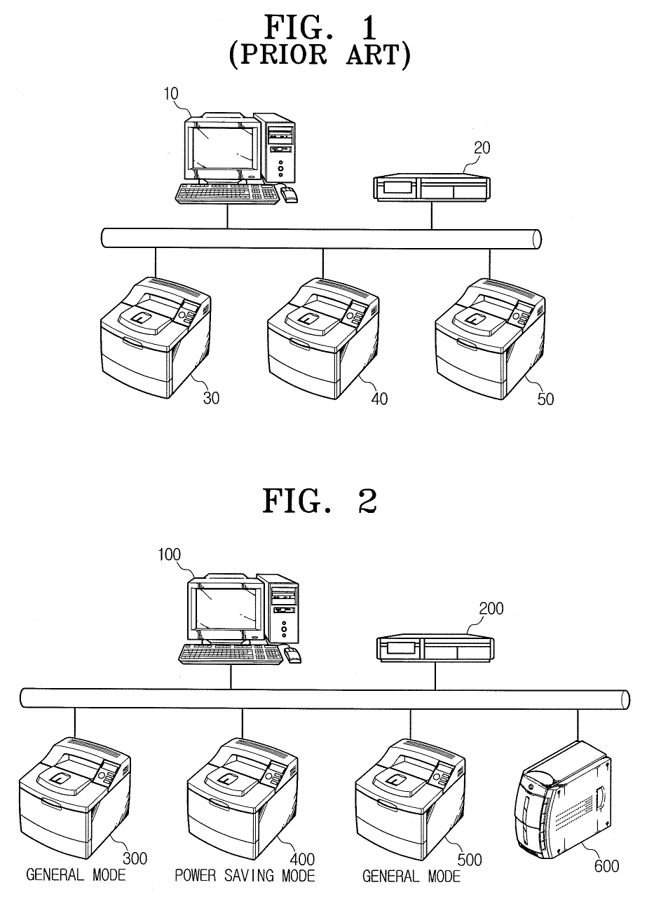

The method of a network device to perform power saving, that is, the network printer 400, is described with reference to FIGS. 1-4.

The network printer 400 may operate in the general mode in operation S700, and if the network printer 400 does not perform any job during a predetermined amount of time, the network printer 400 switches to a power saving mode. If the network printer 400 does not switch to the power saving mode in operation S710-N, the network printer 400 reverts back to operation S700 and continues to operate in the general mode.

If the network printer 400 switches to the power saving mode in operation S710-Y, the network printer 400 transmits a power saving mode change signal to the user terminal 100. The network printer 400 may also transmit the response signal defined to respond to the information request signal from one of other network devices, that is, the router 200, the network printer 300, the network printer 500 and the printer server 600 in operation S720.

After transmitting the power saving mode change signal and the response signal to the user terminal 100, the network printer 400 switches to the power saving mode in operation S730. While in the power saving mode, only the network interface of the network printer 400 operates normally, and other hardware do not operate.

If the network printer 400 receives data through the network interface or switches to the normal mode by a user's manipulation in operation S740-Y, the network printer 400 transmits a general mode change signal to the user terminal in operation 100 S750. If the network printer 400 does not switch to the normal mode in operation S740-N, the network printer 400 continues to operate in the power saving mode.

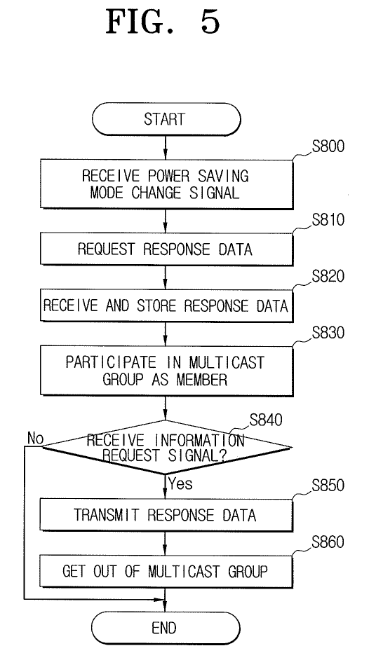

FIG. 5 is a flow chart illustrating a method of the network device to transmit data as an agency of FIG. 3.

The method of the user terminal 100 which transmits data as an agency in response to information request to the network printer 400 is described with reference to FIGS. 1-5.

If the user terminal 100 receives a power saving mode change signal from the network printer 400 through the network interface 110 in operation S800, the controller 130 requests a response data to the network printer 400 in operation S810. If the user terminal 100 receives the response data along with the power saving mode change signal, operation S810 is omitted.

If the network interface 110 receives the response data from the network printer 400, the controller 130 stores the response data in the storage unit 120 in operation S820.

The controller 130 controls the user terminal 100 to participate in a multicast group including the network printer 400 as a member using an address of the multicast group acquired when the power saving mode change signal is received in operation S830. If the user terminal 100 already operates in the multicast group including the network printer 400 as a member, operation S830 is omitted.

If the user terminal 100 operates in the multicast group including the network printer 400 as a member in operation S830, the user terminal 100 can receive an information request signal from one of other network devices, such as the router 200, the network printer 300, the network printer 500 or the printer server 600.

If the user terminal 100 can receive the information request signal for the network printer 400 from one of the router 200, the network printer 300, the network printer 500 and the printer server 600 through the network interface 110 S840-Y, the controller 130 may transmit the response data already stored in the storage unit 120 to the network device which has requested the information in operation S850.

The controller 130 controls the user terminal 100 to remove itself from the multicast group through the network interface 110 in operation S860.

If the network printer 400 operates in a power saving mode, only the network interface normally operates, so the network printer 400 cannot normally respond to the information request signal from one of the router 200, the network printer 300, the network printer 500, and the printer server 600.

If the network printer 400 does not respond to the information request signal, the network device which has requested the information may regard the network printer 400 as not being part of the network.

According to an embodiment of the present general inventive concept, although the network printer 400 operates in a power saving mode, the user terminal 100 transmits the response data as an agency in response to the information request signal, and accordingly the network device which has requested the information recognizes that the network printer 400 operates normally.

As can be appreciated from the above description of a multicasting system and a network device to transmit data as an agency and a method of transmitting data as an agency, other network devices may transmit a response as an agency corresponding to a network device in a power saving mode to minimize power consumption, and accordingly the network device in a power saving mode in the multicasting system can normally receive actual data.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A multicasting system having a plurality of network devices, the multicasting system comprising:
a first network device to transmit a power saving mode change signal and to change a current mode to a power saving mode; and
a second network device to receive the power saving mode change signal from the first network device, and if an information request signal is received from another network device, to transmit response data defined by the first network device to the another network device which has transmitted the information request signal.

2. The multicasting system of claim 1, wherein the second network device requests the response data to be used as a response to the information request signal to the first network device, if the power saving mode change signal is received.

3. The multicasting system of claim 1, wherein the first network device transmits the response data to be used as a response to the information request signal along with the power saving mode change signal.

4. The multicasting system of claim 1, wherein the first network device transmits an address of a multicast group including the first network device, along with the power saving mode change signal.

5. The multicasting system of claim 4, wherein the second network device participates in the multicast group including the first network device as a member using the address of the multicast group, if the power saving mode change signal is received.

6. The multicasting system of claim 5, wherein the second network device is removed from the multicast group if a general mode change signal is received from the first network device.

7. A network device to transmit data as an agency, comprising:
a network interface which to receive a power saving mode change signal from a network device to perform power saving among a plurality of network devices, and response data defined by the network device to perform power saving;
a storage unit to store the received response data; and
a controller to transmit the stored response data to another network device, which has transmitted an information request signal, through the network interface, if the information request signal is received from one of the plurality of network devices.

8. The network device of claim 7, wherein the controller requests the response data to the network device to perform power saving, if the power saving mode change signal is received through the network interface.

9. The network device of claim 7, wherein the controller controls the network device to participate in a multicast group including the network device to perform power saving as a member, if the power saving mode change signal is received through the network interface.

10. The network device of claim 9, wherein the controller controls the network device to remove itself from the multicast group, if a general mode change signal is received from the network device to perform power saving through the network interface.

11. A method of transmitting data as an agency, the method comprising:
receiving a power saving mode change signal and response data from a network device to perform power saving among a plurality of network devices;
storing the received response data; and
if an information request signal is received from one of the plurality of network devices, transmitting the stored response data to the network device which has transmitted the information request signal.

12. The method of claim 11, wherein the receiving of the power saving mode change signal and the response data comprises:
receiving the power saving mode change signal from the network device to perform power saving;
requesting the response data to the network device to perform power saving; and
receiving the response data from the network device to perform power saving.

13. The method of claim 11, further comprising:
participating in a multicast group including the network device to perform power saving as a member, if the power saving mode change signal is received.

14. The method of claim 13, further comprising:
removing a device from the multicast group, if a general mode change signal is received from the network device to perform power saving.

15. A multicasting system having a plurality of network devices, comprising:
a network device to receive response data from one of network devices, to receive an information request signal from another one of the network devices, and to transmit the received response data from the one of the network devices to the another one of the network devices according to the received information request signal as an agency of the one of the network devices.

16. The multicasting system of claim 15, wherein the network devices receives a power saving mode change signal from the one of the network devices and transmit a request signal to the one of the network devices according to the received power saving mode change signal.

17. The multicasting system of claim 15, wherein the network device transmits the received response data to the another one of the network devices according to a power saving mode change signal of the one of the network devices.

18. The multicasting system of claim 15, wherein the network device does not send the received response data to the another one of the network devices according to a mode change signal from the one of the network devices.

19. The multicasting system of claim 15, wherein the one of the network devices changes a mode to a power saving mode upon transmitting the response data to the network device.

20. A method of a multicasting system having a plurality of network devices, the method comprising:
receiving response data from one of network devices;
receiving an information request signal from another one of the network devices; and
transmitting the received response data from the one of the network devices to the another one of the network devices according to the received information request signal as an agency of the one of the network devices.

21. A multicasting system having a plurality of network devices, comprising:
a network device to transmit a power saving mode change signal according to the power saving mode change signal, and to change a mode to a power saving mode upon transmitting response data to the another network device to another network device.

22. A method of a multicasting system having a plurality of network devices, the method comprising:
transmitting a power saving mode change signal according to the power saving mode change signal; and
changing a mode to a power saving mode upon transmitting response data to the another network device to another network device.
